(19) United States
(12) Patent Application Publication
(10) Pub. No.: US 2004/0126708 A1
(43) Pub. Date: Jul. 1, 2004

(54) Method for modifying the surface of a polymeric substrate

(75) Inventors: Naiyong Jing, Woodbury, MN (US); Bradford B. Wright, Woodbury, MN (US); Caroline M. Ylitalo, Stillwater, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/335,494

(22) Filed: Dec. 31, 2002

(51) Int. Cl. C08J 3/28; G03C 1/76; G03C 5/00

(52) U.S. Cl. 430/320; 430/315; 430/523; 430/531; 430/533; 430/907; 438/455; 438/473

(57) ABSTRACT

A process for modifying the surface of a polymeric substrate. The process includes digitally applying a photoreactive material comprising at least one photochemical electron donor to a region of a polymeric substrate and exposing at least a portion of that region to actinic radiation. The modified surface of the polymeric substrate may be bonded to one or more additional substrates, or may be coated with a fluid.

### BACKGROUND

The present invention relates to methods for modifying the surface of a polymeric substrate.

The ability to wet a polymer surface with a fluid, or bond a polymer surface to another material (e.g., another polymer), typically depends on the surface energy of the polymer surface. Many methods have been devised to modify the surface of various polymers.

One such method involves the photochemical modification of the polymer surface, in which the interaction between light and matter typically results in a change in the surface properties of the polymer surface. For example, hydrophobic fluoropolymer surfaces may be made hydrophilic by exposure to actinic radiation (i.e., ultraviolet and/or visible electromagnetic radiation) while such surfaces are in intimate contact with one or more photoreactive materials selected for their ability to participate in photoelectron transfer reactions with the fluoropolymer. Both organic photoreactive materials (e.g., organic amines) and inorganic photoreactive materials (e.g., thiosulfate salts) have been used to modify fluoropolymer surfaces by this method.

In typical photochemical surface modification methods, the entire surface to be modified is contacted with a photoreactive material and exposed to actinic radiation. Such methods are typically not capable of forming detailed patterns of surface modification without passing the actinic radiation through an opaque mask that blocks actinic radiation from reaching regions in which no surface modification is desired. Such masking procedures are typically cumbersome, expensive, and not well suited for applications in which patterns are frequently changed. It would be desirable to have methods for easily modifying the surface of a polymer (e.g., a fluoropolymer) that would eliminate the need for masking the actinic radiation in order to generate patterns of surface modification on the polymer surface.

### SUMMARY

In one aspect, the invention provides a process for modifying a polymeric substrate surface comprising:

providing a first polymeric substrate having a first surface;

digitally applying a photoreactive material comprising at least one photochemical electron donor to a first region of the first surface; and

exposing at least a portion of the first region to actinic radiation.

In another aspect, the invention provides a process for modifying a polymeric substrate surface comprising:

providing a first polymeric substrate having a first surface;

digitally applying a photoreactive material comprising at least one photochemical electron donor to a first region of the first surface;

exposing at least a portion of the first region to actinic radiation;

applying a secondary substrate to the first surface of the first substrate after the first region has been exposed to actinic radiation; and

adhering the exposed first region to the first substrate.

In another aspect, the invention provides a process for modifying a polymeric substrate surface comprising:

providing a first polymeric substrate having a first surface;

digitally applying a photoreactive material comprising at least one photochemical electron donor to a first region of the first surface;

exposing at least a portion of the first region to actinic radiation; and

applying a fluid to the first surface of the first substrate after the first region has been exposed to actinic radiation.

In some embodiments, the present invention may be practiced using digitally controlled non-contact fluid deposition methods such as spray jet, valve jet, or ink jet printing technology.

Polymeric substrates having surfaces that are modified according to the present invention may exhibit improved adhesion when bonded to another solid substrate (e.g., to form a composite article).

As used in this application:

“actinic radiation” means electromagnetic radiation having at least one wavelength in a range of from about 200 nanometers to about 700 nanometers;

“inorganic” means having neither a C—H bond, nor a carbon to carbon multiple bond, nor a tetracoordinate carbon atom; in embodiments of the invention in which an inorganic photochemical electron donor is ionic, the term “inorganic” refers to the anionic portion of the ionic compound only, that is, the cationic portion of the ionic compound, which is present of necessity to maintain the overall charge balance, may therefore be organic as in the case of, for example, tetraalkylammonium thiocyanate;

“non-volatile salt” refers to a salt consisting of a cation and an anion, wherein the cation, and any corresponding conjugate base that may exist in equilibrium with the cation, have a combined vapor pressure of less than about 10 millipascals at 25° C.;

“organic” means not inorganic as defined herein;

“photochemical electron donor” refers to a compound that undergoes photochemical one-electron oxidation; and

“soluble” means dissolvable in the chosen solvent at concentrations exceeding about 0.001 mole per liter.

### BRIEF DESCRIPTION OF THE DRAWINGS

FIG. 1 is a cross-sectional view of a composite article according to one embodiment of the present invention; and

FIG. 2 is a representation of an ink jet printing pattern used in the examples.

### DETAILED DESCRIPTION

According to the present invention, a photoreactive material comprising at least one photochemical electron donor is typically applied in an image-wise fashion to a first region of the surface of a polymeric substrate, and at least a portion of the first region is exposed to actinic radiation causing the exposed portion of the first region of the polymeric substrate to become surface modified. The degree of surface modification may be determined by various well known surface analysis techniques including, but not limited to, Attenuated Total internal Reflectance infrared spectroscopy (ATR IR) and Electron Scattering for Chemical Analysis (ESCA), as well as contact angle measurements.

Polymeric substrates that may be modified according to the methods of the invention typically comprise polymeric organic material, and may be of any shape, form, or size. The polymeric organic material may be thermoplastic, thermoset, elastomeric, or other.

Suitable polymeric organic materials include polyimides, polyesters, and fluoropolymers. Exemplary useful polyimides include modified polyimides such as polyester imides, polysiloxane imides, and polyether imides. Many polyimides are commercially available, for example, from E.I. DuPont de Nemours and Company under the trade designation “KAPTON” (e.g., “KAPTON H”, “KAPTON E”, “KAPTON V”).

Exemplary useful polyesters include polyethylene terephthalate, polybutylene terephthalate, polycyclohexylenedimethylene terephthalate, and blends and copolymers thereof. Commercially available polyesters include those available under the trade designation “VITEL” from Bostik, Middleton, Mass., or under the trade designation “DYNAPOL” from Huls AG, Marl, Germany.

Useful fluoropolymers include perfluorinated polymers (i.e., those containing less than 3.2 percent by weight hydrogen, and which may have chlorine or bromine atoms in place of some of the fluorine atoms) or partially fluorinated polymers. For example, the polymeric organic material may be a homopolymer or copolymer of tetrafluoroethylene (i.e., TFE).

The fluoropolymer may be melt-processable, such as in the case of polyvinylidene fluoride (i.e., PVDF), a terpolymer of tetrafluoroethylene, hexafluoropropylene, and vinylidene fluoride (i.e., THV), a tetrafluoroethylene-hexafluoropropylene copolymer, and other melt-processable fluoroplastics. Alternatively, the fluoropolymer may not be melt-processable, such as in the case of polytetrafluoroethylene, modified polytetrafluoroethylene copolymers (e.g., copolymers of TFE and low levels of fluorinated vinyl ethers), and cured fluoroelastomers.

The fluoropolymer may be a material that is capable of being extruded or solvent coated. Such fluoropolymers typically are fluoroplastics that have melting temperatures in a range of from at least about 100° C. (e.g., at least about 150° C.) up to about 330° C. (e.g., up to about 270° C.), although fluoropolymers with higher or lower melt temperatures may be used. Useful fluoroplastics may have copolymerized units derived from vinylidene fluoride (i.e., VDF) and/or TFE, and may further include copolymerized units derived from other fluorine-containing monomers, non-fluorine-containing monomers, or a combination thereof. Exemplary fluorine-containing monomers include TFE, hexafluoropropylene (i.e., HFP), chlorotrifluoroethylene, 3-chloropentafluoropropylene, perfluorinated vinyl ethers (e.g., perfluoroalkoxy vinyl ethers such as CF₃OCF₂CF₂CF₂OCF═CF₂, and perfluoroalkyl vinyl ethers such as CF₃OCF═CF₂ and CF₃CF₂CF₂OCF═CF₂), and fluorine-containing di-olefins (e.g., perfluorodiallyl ether, perfluoro-1,3-butadiene). Exemplary non-fluorine-containing monomers include olefin monomers (e.g., ethylene, propylene).

VDF-containing fluoropolymers may be prepared using emulsion polymerization techniques as described, for example, in U.S. Pat. No. 4,338,237 (Sulzbach et al.) or U.S. Pat. No. 5,285,002 (Grootaert), the disclosures of which are incorporated herein by reference. Exemplary commercially available VDF-containing fluoroplastics include those fluoropolymers having the trade designations DYNEON “THV 200”, “THV 400”, “THVG”, and “THV 610X” (available from Dyneon, Oakdale, Minn.), “KYNAR 740” (available from Atochem North America, Philadelphia, Pa.), “HYLAR 700” (available from Ausimont U.S.A., Morristown, N.J.), and “FLUOREL FC-2178” (available from Dyneon).

One useful fluoropolymer has copolymerized units derived from at least TFE and VDF in which the amount of VDF is at least about 0.1 percent by weight (e.g., at least about 3 percent by weight or at least about 10 percent by weight) and less than 20 percent by weight (e.g., less than about 15 percent by weight), based on the total weight of the polymer.

Fluoroelastomers may be processed before they are cured by injection or compression molding or other methods normally associated with thermoplastics. After curing or crosslinking, fluoroelastomers may not be able to be further melt-processed. Fluoroelastomers may be coated out of solvent in their uncrosslinked form. Fluoropolymers may also be coated from an aqueous dispersion form. Suitable fluoropolymers include tetrafluoroethylene-hexafluoropropylene copolymers, tetrafluoroethylene-perfluoro(alkyl vinyl ether) copolymers (e.g., tetrafluoroethylene-perfluoro(propyl vinyl ether)), perfluoroelastomers (e.g., VDF-HFP copolymers, VDF-HFP-TFE terpolymers, TFE-propylene copolymers, and mixtures thereof), and mixtures thereof.

The polymeric substrate may be provided in any form (e.g., film, sheet, shaped article), and may comprise two or more layers of different materials. In some embodiments according to the present invention, the polymeric substrate may comprise a blend of two or more polymers. Polymeric films may be prepared by known techniques including casting or melt extrusion.

According to the present invention, the photochemical electron donor, polymeric substrate, and optional sensitizer are selected such that the excitation energy of the lowest excited state of the light absorbing species (e.g., polymeric substrate, photochemical electron donor, optional sensitizer) has sufficient energy to cause oxidation of the photochemical electron donor and reduction of the polymeric substrate.

In practice, this may be determined, for example, by selecting the polymeric substrate, photochemical electron donor, and optional sensitizer such that the oxidation potential (in volts) of the photochemical electron donor minus the reduction potential (in volts) of the surface of the polymeric substrate minus the excitation energy of the excited species (i.e., energy of the lowest lying triplet excited state of the light absorbing species) is less than zero.

Oxidation potentials (and reduction potentials) of compounds can be determined by methods known to those skilled in the art, for example, by polarography. For example, methods for measuring oxidation potentials are described by A. J. Bard and L. R. Faulkner, “Electrochemical Methods, Fundamentals and Applications,” John Wiley & Sons, Inc., New York (2001); and by D. T. Sawyer and J. L. Roberts, “Experimental Electrochemistry for Chemists” John Wiley & Sons, New York (1974), pp. 329-394.

Reduction potentials of polymers can be determined in several ways, especially electrochemically, as described, for example, by D. J. Barker, “The Electrochemical Reduction of Polytetrafluoroethylene,” Electrochimica Acta, 1978, vol. 23, pp. 1107-1110; D. M. Brewis, “Reactions of polytetrafluoroethylene with Electrochemically Generated Intermediates,” Die Angewandte Makromolekulare Chemie, 1975, vol. 43, pp. 191-194; S. Mazur and S. Reich, “Electrochemical Growth of Metal Interlayers in Polyimide Film,” The Journal of Physical Chemistry, 1986, vol. 90, pp. 1365-1372. If the reduction potential of any particular polymer has not been measured, an approximation can be conveniently made, subject to verification, by using the reduction potential of a model compound that is structurally similar to the polymer. The reduction potential of a large number of organic compounds has been compiled by L. Meites, P. Zuman and (in part) E. Rupp, CRC Handbook Series in Organic Electrochemistry, vols. 1-6, CRC Press, Cleveland, published 1977-1983.

As is well known to those skilled in the art, oxidation and reduction potentials may vary somewhat with various experimental parameters. In such circumstances, oxidation and reduction potentials should be measured under conditions according to those used in the practice of the invention (for example, such as by using the same solvent, concentration, temperature, pH, etc.).

“Excitation energy,” as used herein, refers to the lowest energy triplet state of the light absorbing species (e.g., the photochemical electron donor, sensitizer, or substrate). Methods for measurement of such energies are well known in the art and may be determined by phosphorescence measurements as described by, for example, R. S. Becker, “Theory and Interpretation of Fluorescence and Phosphorescence,” Wiley Interscience, New York, 1969, Chapter 7. Spectrophotometers capable of making such measurements are readily available from companies, such as Jasco (Easton, Md.) and Photon Technology International (Lawrenceville, N.J.).

Oxygen perturbation techniques may also be used to measure triplet state energy levels as described in D. F. Evans, “Perturbation of Singlet-Triplet Transitions of Aromatic Molecules by Oxygen under Pressure,” The Journal of the Chemical Society (London), 1957, pp. 1351-1357. The oxygen perturbation technique involves measuring the absorption spectrum of a compound while that compound is under an oxygen enhanced high-pressure environment, for example, 13.8 megapascals. Under these conditions, spin selection rules break down and exposure of the compound to actinic radiation generates the lowest excited triplet state directly from the ground state. The wavelength (i.e., λ), at which this transition occurs is used to calculate the energy of the lowest energy triplet state using the relationship of E=hc/λ, wherein E is the triplet state energy, h is Planck's constant, and c is the speed of light in a vacuum.

The photochemical electron donor may be organic, inorganic, or a mixture of organic and inorganic species. Photochemical electron donors used in practice of the invention are typically selected based on the nature of the polymeric substrate and their ability to satisfy the selection criteria for photochemical electron donor, polymeric substrate, and optional sensitizer given hereinabove.

Suitable organic photochemical electron donors include organic amines (e.g., aromatic amines, aliphatic amines), aromatic phosphines, aromatic thioethers, thiophenols, thiolates, and mixtures thereof. Useful organic amines may be mono-, di-, or tri-substituted amines (e.g., alkylamines, arylamines, alkenylamines), including amino-substituted organosilanes (e.g., amino-substituted organosilanes having at least one hydrolyzable substituent). Exemplary aromatic amines include aniline and its derivatives (e.g., N,N-dialkylaniline, N-alkylaniline, aniline).

In some embodiments according to the present invention, the organic photochemical electron donor may have a fluorinated moiety, such as a fluoroalkyl group. In some cases, the presence of a fluorinated moiety may aide in wetout. Exemplary fluorinated organic photochemical electron donors include N-methyl-N-2,2,2-trifluoroethylaniline, N-2,2,2-trifluoroethylaniline, 4-(n-perfluorobutyl)-N,N-dimethylaniline, 4-(pentafluoroisopropyl)-N,N-dimethylaniline, 4-(perfluorotetrahydrofurfuryl)-N,N-dimethylaniline, N,N-diethyl-2,2,2-trifluoroethylamine, N,N-dimethylaniline, triethylamine, and phenylaminopropyltriethoxysilane.

Useful inorganic photochemical electron donors include neutral inorganic compounds and inorganic anions. Exemplary neutral inorganic photochemical electron donors include ammonia, hydrazine, and hydroxylamine. If the inorganic photochemical electron donor is anionic, it is typically provided in the form of a salt with a cation. Exemplary cations include alkali metal cations (e.g., Li⁺, Na⁺, K⁺), alkaline earth cations (e.g., Mg²⁺, Ca²⁺), organoammonium cations, amidinium cations, guanidinium cations, organosulfonium cations, organophosphonium cations, organoarsonium cations, organoiodonium cations, and ammonium.

Exemplary salts that contain inorganic photochemical electron anions include:

(a) sulfur-containing salts such as thiocyanate salts (e.g., potassium thiocyanate and tetraalkylammonium thiocyanate), sulfide salts (e.g., sodium sulfide, potassium hydrosulfide, sodium disulfide, sodium tetrasulfide), thiocarbonate salts (e.g., sodium thiocarbonate, potassium trithiocarbonate), thiooxalate salts (e.g., potassium dithiooxalate, sodium tetrathiooxalate), thiophosphate salts (e.g., cesium thiophosphate, potassium dithiophosphate, sodium monothiophosphate), thiosulfate salts (e.g., sodium thiosulfate), dithionite salts (e.g., potassium dithionite), sulfite salts (e.g., sodium sulfite);

(b) selenium-containing salts such as selenocyanate salts (e.g., potassium selenocyanate), selenide salts (e.g., sodium selenide);

(c) inorganic nitrogen-containing salts such as azide salts (e.g., sodium azide, potassium azide); and

(d) iodine containing salts such as iodide, triiodide;

and mixtures thereof.

Photochemical electron donors useful in practice of the invention may exist in aqueous solution in equilibrium with various species (e.g., as a conjugate acid or conjugate base). In such cases, the solution pH may be adjusted to maximize the concentration of the preferred species.

The photochemical electron donor may be dissolved in a solvent; for example, a solvent that is not reactive with the photochemical electron donor in the absence of actinic radiation. Preferably, solvents for such photoreactive materials should not significantly absorb actinic radiation at the same wavelength as the inorganic photochemical electron donor, or any sensitizer, if present. While it may be preferable in some instances to choose a solvent that is more difficult to reduce than the polymeric substrate in order to avoid possible side reactions, the invention may also be practiced in some solvents (e.g., aqueous solvents) in which the solvent may be more easily reduced than the polymeric substrate.

Essentially, any known solvent may be employed, with the particular choice being determined by solubility and compatibility of the various components of the photoreactive material, the polymeric substrate, absorption spectrum, the compatibility with the jetting device to be used, etc. If used, any solvent is preferably selected such that it does not dissolve, or significantly swell, the polymeric substrate. Exemplary useful solvents include water and organic solvents including alcohols (e.g., methanol, ethanol, n-propanol, isopropanol, n-butanol, sec-butanol, t-butanol, iso-butanol, ethylene glycol, diethylene glycol, triethylene glycol, propylene glycol, butylene glycol, 1,4-butanediol, 1,2,4-butanetriol, 1,5-pentanediol, 1,2,6-hexanetriol, hexylene glycol, glycerol, diacetone alcohol), ketones (e.g., acetone, methyl ethyl ketone), esters (e.g., ethyl acetate, ethyl lactate), and lower alkyl ethers (e.g., ethylene glycol monomethyl ether, diethylene glycol methyl ether, triethylene glycol monomethyl ether), and mixtures thereof.

Typically, the concentration of the photochemical electron donor in the solvent is in a range of from at least about 0.001 mole per liter (e.g., 0.01 mole per liter) and less than about 1 mole per liter (e.g., 0.1 mole per liter), although other concentrations may also be used.

Depending on the choice of solvent and polymeric substrate, differing surface modifications may be obtained. For example, in aqueous solvents, hydroxyl groups are typically abundant on the surface of the fluoropolymer.

The photoreactive material may optionally include a cationic assistant. The cationic assistant is a compound (i.e., a salt) consisting of an organic cation and a non-interfering anion. The term “non-interfering anion” refers to an anion (organic or inorganic) that does not substantially react with the polymeric substrate surface at 20° C. during a period of 5 minutes in the absence of actinic radiation. Exemplary non-interfering anions meeting this criterion include halides (e.g., bromide, chloride, fluoride); sulfate; sulfonate (e.g., para-toluenesulfonate); phosphate; phosphonate; complex metal halides (e.g., hexafluorophosphate, hexafluoroantimonate, tetrachlorostannate); perchlorate; nitrate; carbonate; and bicarbonate. The non-interfering anion may be an anion that can function as a photochemical electron donor.

Useful cationic assistants include organosulfonium salts, organoarsonium salts, organoantimonium salts, organoiodonium salts, organophosphonium salts, organoammonium salts, and mixtures thereof. Salts of these types have been previously described in, for example, U.S. Pat. No. 4,233,421 (Worm); U.S. Pat. No. 4,912,171 (Grootaert et al.); U.S. Pat. No. 5,086,123 (Guenthner et al.); and U.S. Pat. No. 5,262,490 (Kolb et al.).

Suitable organophosphonium salts include non-fluorinated organophosphonium salts (e.g., tetraphenylphosphonium chloride, tetraphenylphosphonium bromide, tetraoctylphosphonium chloride, tetra-n-butylphosphonium chloride, tetraethylphosphonium chloride, tetramethylphosphonium chloride, tetramethylphosphonium bromide, benzyltriphenylphosphonium chloride, benzyltriphenylphosphonium bromide, benzyltriphenylphosphonium stearate, benzyltriphenylphosphonium benzoate, triphenylisobutylphosphonium bromide, n-butyltrioctylphosphonium chloride, benzyltrioctylphosphonium chloride, benzyltrioctylphosphonium acetate, 2,4-dichlorobenzyltriphenylphosphonium chloride, (methoxyethyl)trioctylphosphonium chloride, triphenyl(ethoxycarbonylmethyl)-phosphonium chloride, allyltriphenylphosphonium chloride), and fluorinated organophosphonium salts (e.g., trimethyl(1,1-dihydroperfluorobutyl)phosphonium chloride, benzyl-[3-(1,1-dihydroperfluoropropoxy)propyl]diisobutylphosphonium chloride), benzylbis[3-(1,1-dihydroperfluoropropoxy)propyl]isobutylphosphonium chloride), C₆F₁₃CH₂CH₂P(CH₂CH₂CH₂CH₃)₃⁺I⁻), and the like.

The cationic assistant may be an organoammonium salt. Suitable ammonium salts include non-fluorinated organoammonium salts, such as, for example, tetraphenylammonium chloride, tetraphenylammonium bromide, tetraoctylammonium chloride, tetra-n-butylammonium chloride, tetraethylammonium chloride, tetramethylammonium chloride, tetramethylammonium bromide, benzyltributylammonium chloride, triphenylbenzylammonium fluoride, triphenylbenzylammonium bromide, triphenylbenzylammonium acetate, triphenylbenzylammonium benzoate, triphenylisobutylammonium bromide, trioctyl-n-butylammonium chloride, trioctylbenzylammonium chloride, trioctylbenzylammonium acetate, triphenyl-2,4-dichlorobenzylammonium chloride, trioctylmethoxyethoxyethylammonium chloride, triphenylethoxycarbonylmethylammonium chloride, triphenylallylammonium chloride, and 1-butylpyridinium chloride; and fluorinated organoammonium salts, such as trimethyl(1,1-dihydroperfluorobutyl)ammonium chloride, C₇F₁₅CONHCH₂CH₂NMe₃⁺I⁻, C₄F₉OCF₂CF₂OCF₂CH₂CONHCH₂CH₂NMe₃⁺I⁻.

The presence of a fluorinated anionic surfactant (e.g., perfluoroalkanoate salts, such as perfluorooctanoate salts) in the photoreactive material, especially when the photoreactive material is aqueous, may reduce the observed rate of surface modification, and bonding capability of the surface modified polymeric substrate. For this reason, it may be preferable that the photoreactive material is substantially free of (for example, less than an amount sufficient to achieve about a monolayer coverage) fluorinated anionic surfactant on the polymeric substrate surface to be modified.

In order for surface modification to occur, actinic radiation must typically either be absorbed by the photochemical electron donor, by the polymeric substrate, or by another material (e.g., a sensitizer). A sensitizer is a compound, or in the case of a salt an ionic portion of a compound (e.g., an anion or cation), that by itself is not an effective photoreactive material of the polymer surface properties with or without the presence of actinic radiation, but that absorbs light and subsequently facilitates modification of the polymeric substrate surface by the photochemical electron donor. Thus, if a sensitizer is used, it should typically have a sufficiently high triplet excited state energy to facilitate photoreduction of the polymeric substrate by the photochemical electron donor.

Exemplary sensitizers include aromatic hydrocarbons (e.g., benzene, naphthalene, toluene, styrene, anthracene), aromatic ethers (e.g., diphenyl ether, anisole), aryl ketones (e.g., benzophenone, acetophenone, xanthone), aromatic thioethers (e.g., diphenyl sulfide, methyl phenyl sulfide), and water-soluble modifications thereof. Typical concentrations for sensitizers, if used, are from about 0.001 to about 0.1 moles/liter.

The photoreactive material may contain additional additives such as, for example, crown ethers and cryptands that may improve dissociation of ionic salts and may be beneficial in some instances (e.g., low polarity solvents). Exemplary crown ethers include 15-crown-5, 12-crown-4, 18-crown-6, 21-crown-7, dibenzo-18-crown-6, dicyclohexyl-18-crown-6, benzo-15-crown-5 which may be readily obtained from commercial sources, such as Aldrich Chemical Co. (Milwaukee, Wis.).

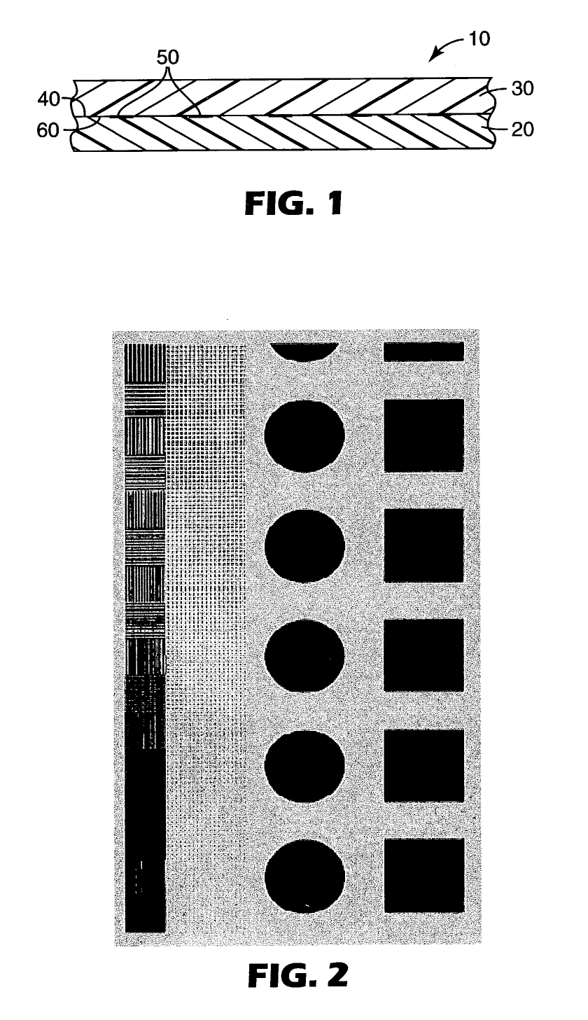

Additional optional additives include nucleophiles (i.e., materials that have a preferential attraction to regions of low electron density) such as, for example, water, hydroxide, alcohols, alkoxides, cyanide, cyanate, chloride, and mixtures thereof. The surface of the polymeric substrate, once modified according to the present invention, may be bonded to a secondary substrate that may be organic or inorganic as shown in FIG. 1. Referring now to FIG. 1, composite article 10 comprises polymeric substrate 20 having distinct regions of modified surface layer 50 that are the result of contacting a photoreactive material with polymeric substrate surface 60, and subsequently exposing the interface to actinic radiation. Surface 40 of second substrate 30 is bonded to distinct regions of modified surface layer 50. Surface layer 50 typically has a thickness on the order of molecular dimensions, for example, 10 nanometers or less.

Bonding of the surface modified regions of polymeric substrate to the secondary substrate may be accomplished, for example, by contacting the secondary substrate (e.g., a polymer film) with a modified surface of the polymeric substrate and applying heat (e.g., elevated temperature) and/or pressure, preferably using both heat and pressure. Suitable heat sources include, but are not limited to, ovens, heated rollers, heated presses, infrared radiation sources, flame, and the like. Suitable pressure sources are well known and include presses, nip rollers, and the like. The necessary amounts of heat and pressure will depend on the specific materials to be bonded, and may be easily determined.

The secondary substrate may comprise a polymer film, metal, glass, or other. For example, the secondary substrate may be a film comprising a fluoropolymer or a non-fluorinated polymer that may be the same as, or different from, the polymeric substrate. Exemplary non-fluorinated polymers that may comprise the secondary substrate include polyamides, polyolefins, polyethers, polyurethanes, polyesters, polyimides, polystyrene, polycarbonates, polyketones, polyureas, acrylics, and mixtures thereof. Exemplary non-fluorinated polymers include non-fluorinated elastomers (e.g., acrylonitrile butadiene rubber (NBR), butadiene rubber, chlorinated and chlorosulfonated polyethylene, chloroprene, ethylene-propylene monomer (EPM) rubber, ethylene-propylene-diene monomer (EPDM) rubber, epichlorohydrin (ECO) rubber, polyisobutylene, polyisoprene, polyurethane, silicone rubber, blends of polyvinyl chloride and NBR, styrene butadiene (SBR) rubber, ethylene-acrylate copolymer rubber, ethylene-vinyl acetate rubber), polyamides (e.g., nylon-6, nylon-6,6, nylon-11, nylon-12, nylon-6,12, nylon-6,9, nylon-4, nylon-4,2, nylon-4,6, nylon-7, nylon-8, nylon-6,T and nylon-6,1), nonelastomeric polyolefins (e.g., polyethylene, polypropylene), polycarbonates, polyimides, polyesters, polyketones, and polyureas.

The secondary substrate may have polar groups on its surface, for example, to aid in forming a strong adhesive bond. Polar groups may be introduced by known techniques, including for example, corona treatment, etc.

In certain situations, more than two secondary substrates (e.g., two polymer films) may contact more than one surface of the polymeric substrate (e.g., a three layer film sandwich construction). In still other situations, two polymeric substrates may contact two surfaces of the secondary substrate.

In some instances (e.g., sequential polymeric substrate modification and bonding processes), it may be desirable to rinse (e.g., with solvent) the surface of the modified polymeric substrate after modification. Rinsing typically removes components from the photoreactive material that are not directly bonded to the polymeric substrate.

Actinic radiation is electromagnetic radiation having a wavelength capable of modifying the polymeric substrate in the presence of the photoreactive material. For example, the actinic radiation may have sufficient intensity and wavelength such that surface modification occurs within less than about 10 minutes (e.g., less than about 3 minutes). The actinic radiation may have a wavelength of from about 200 nanometers (e.g., at least about 240 nanometers, or at least about 250 nanometers) to about 700 nanometers (e.g., no greater than about 400 nanometers, or no greater than about 300 nanometers, or no more than about 260 nanometers). Actinic radiation may also include longer wavelength photons supplied at sufficient intensity (e.g., by using a pulsed laser) to be absorbed simultaneously.

Typical sources of actinic radiation often have multiple or continuous wavelength outputs, although lasers may be used. Such sources are typically suitable as long as at least some of their output is at one or more wavelengths absorbed by the photochemical electron donor, polymeric substrate, and/or optional sensitizer. To ensure efficient use of the actinic radiation, the wavelength of the actinic radiation used may be chosen such that the molar absorptivity of the photochemical electron donor and/or optional sensitizer at such wavelengths is greater than about 100 liter/mole-centimeter (e.g., greater than about 1,000 liter/mole-centimeter, greater than about 10,000 liter/mole-centimeter). Absorption spectra of many compounds, from which molar absorptivities may be calculated, are commonly available, or may be measured by methods well known to those skilled in the art. In some embodiments according to the present invention, UVC ultraviolet radiation (i.e., ultraviolet radiation having a wavelength of less than 290 nanometers) may be useful.

Suitable sources of actinic radiation include mercury, for example, low-pressure mercury and medium-pressure mercury arc lamps, xenon arc lamps, carbon arc lamps, tungsten filament lamps, lasers (e.g., excimer lasers), microwave-driven lamps (e.g., those sold by Fusion UV Systems of Gaithersburg, Md. (including H-type and D-type bulbs)), flash lamps (e.g., xenon flash lamps), sunlight, and so forth. Low-pressure (e.g., germicidal) mercury lamps are typically highly efficient, convenient sources of actinic radiation.

A filter may optionally be used to absorb some wavelengths while allowing other wavelengths to pass. A filter may also be used to control the relative amounts of actinic radiation that reach selected regions of the polymer surface. A mask may optionally be used to prevent selected regions of the polymer surface from being exposed to actinic radiation.

The duration of exposure to actinic radiation may be from less than about 1 second to 10 minutes or more, depending upon the absorption parameters and specific processing conditions used. In embodiments of the invention, wherein the polymeric substrate is transparent or translucent, actinic radiation may be advantageously directed to the photoreactive material/polymeric substrate interface by passing through the polymeric substrate without passing through the photoreactive material.

In cases wherein the actinic radiation must pass through the photoreactive material prior to encountering the interface, it may be advantageous to achieve a thin layer (e.g., having a thickness of less than about 20 micrometers) of the photoreactive material. Such thin coatings may be difficult or impossible to achieve by standard coating techniques (e.g., knife coating, roll coating) or by immersion. In some cases, the thickness of the photoreactive material can be reduced by applying a load to the photoreactive material after it has been applied to the substrate (e.g., by passing the photoreactive material and the polymer substrate under a nip roller, or by placing a glass slide on the photoreactive solution). However, the application of a load to reduce the thickness of the photoreactive material after it is applied will cause the photoreactive material to spread laterally, which may make the creation of detailed patterns difficult. In such cases, it may be desirable to achieve a thin layer of photoreactive material free of an applied load.

According to the present invention, thin coatings may be achieved in some cases by using digital printing techniques (e.g., ink jet printing) to apply the photoreactive material to the polymeric substrate.

The photoreactive material may be applied to distinct regions of the polymer surface using digital imaging techniques (e.g., those digital imaging techniques that employ a fluid). Suitable digital imaging techniques include, for example, spray jet, valve jet, and ink jet printing methods. Such methods are well known and are described, for example, in U.S. Publication No. 2002/0085054 A1 (Tokie, published Jul. 4, 2002), the disclosure of which is incorporated herein by reference. Ink jet printing techniques are often well suited for applications requiring high resolution.

Various ink jet printing technologies may be used in practice of the present invention, including thermal ink jet printing, continuous ink jet printing, and piezoelectric (i.e., piezo) ink jet printing. Thermal ink jet printers and/or print heads are readily commercially available from printer manufacturers such as Hewlett-Packard Corporation (Palo Alto, Calif.), and Lexmark International (Lexington, Ky.). Continuous ink jet print heads are commercially available from continuous printer manufacturers such as Domino Printing Sciences (Cambridge, United Kingdom). Piezo ink jet print heads are commercially available from, for example, Trident International (Brookfield, Conn.), Epson (Torrance, Calif.), Hitachi Data Systems Corporation (Santa Clara, Calif.), Xaar PLC (Cambridge, United Kingdom), Spectra (Lebanon, N.H.), and Idanit Technologies, Limited (Rishon Le Zion, Israel). Piezo ink jet printing is one useful method for applying the photoreactive material that typically has the flexibility to accommodate various fluids with a wide range of physical and chemical properties.

The photoreactive material is typically formulated to have sufficiently low viscosity properties so that it may be applied to the polymeric surface by the particular digital printing technique chosen. For ink jet printing techniques, the photoreactive material may be formulated to have a viscosity of less than about 30 mPa·s (e.g., less than about 25 mPa·s, less than about 20 mPa·s) at the jetting temperature (typically in a range of from about 25° C. to about 65° C.). However, the optimum viscosity characteristics for a particular solution will depend upon the jetting temperature and the type of ink jet system that will be used to apply the solution.

The photoreactive material is typically formulated to have sufficiently low surface tension so that it may be applied to the polymeric surface by the particular digital printing technique chosen. For example, for ink jet printing the photoreactive material may have a surface tension in a range of from about 20 mN/m (e.g., about 22 mN/m) to about 50 mN/m (e.g., about 40 mN/m) at the jetting temperature.

The photoreactive material may be Newtonian or non-Newtonian (i.e., fluids that exhibit substantial shear thinning behavior). For ink jet printing, the photoreactive material is preferably formulated to exhibit little or no shear thinning at the jetting temperature.

The photoreactive material may be applied to any portion of the surface by various techniques including, for example, moving the polymeric substrate relative to a fixed print head, or by moving print head relative to the polymeric substrate. Accordingly, the methods of the current invention are capable of forming detailed patterns of the photoreactive material (and subsequent surface modification) of the surface of a polymeric substrate without the various disadvantages of applying the photoreactive material to the entire polymer surface.

The photoreactive material is typically applied to the substrate in a predetermined pattern, although random, or pseudo-random placement of the photoreactive material may also be useful in some instances. Exemplary patterns that may be formed by applying the photoreactive material include lines (e.g., straight, curved, or bent lines), two dimensional geometric shapes (e.g., circles, triangles, or squares), alphanumeric symbols (e.g., letters or numbers), and graphical symbols (e.g., corporate logos, animals, plants). After exposure of such patterns to actinic radiation according to the present invention, the surface of the polymeric substrate typically becomes modified with the corresponding pattern. Accordingly, a polymeric substrate having a low surface energy (e.g., a fluoropolymeric substrate) may have a pattern of relatively higher surface energy (e.g., lesser fluorinated or non-fluorinated) formed on at least one surface thereof. Consequently, if a high surface energy fluid (e.g., water) is placed onto the pattern, it is thus possible to confine the wet out (and flow) of the fluid to the modified portions of the patterned surface. Thus, the present invention is useful for the construction of fluidic paths (e.g., microfluidic paths) that may be used in for example a microfluidic device.

In some embodiments according to the present invention, the modified surface of the polymeric substrate may be flood coated by a fluid such that the fluid wets only either the modified or unmodified regions of the surface. For example, a polymeric substrate having a low surface energy (e.g., a fluoropolymeric substrate) may have a pattern of relatively higher surface energy (e.g., lesser fluorinated or non-fluorinated) formed on at least one surface thereof. Consequently, if a high surface energy fluid (e.g., water) is flood coated (e.g., sprayed, roll coated, dip coated) onto the modified surface, it is thus possible to confine the wet out of the fluid to the modified portions of the patterned surface. This technique may be advantageous if the fluid is difficult to apply with conventional jetting techniques (e.g., high viscosity fluids), if the fluid comprises shear sensitive materials (e.g., proteins, which may denature at high shear stresses or shear rates), or if the fluid comprises difficult to jet materials (e.g., flakes, particles (e.g., pigment particles), microspheres, retroreflective beads, fibers). Thus, the present invention is useful for creating digitally generated patterns of a fluid on a substrate without digitally printing the fluid.

In some embodiments according to the present invention, the modified surface of the polymeric substrate may be derivatized by treatment with one or more chemical compounds. For example, in one embodiment the surface of a polymeric substrate modified according to the present invention to have exposed reactive amino groups may be used to immobilize biologically active molecules having amine reactive groups thereon.

In another embodiment, the surface of a polymeric substrate modified according to the present invention to have a pattern of exposed amino groups may be treated with an electroless plating catalyst (e.g., colloidal tin-palladium catalyst), whereby the catalyst is preferentially bound to the amino groups. Subsequent exposure to an electroless plating solution results in deposition of a metal (e.g., copper, nickel, gold, palladium) according to the original pattern. Metallic patterns can thus be created on the surface of polymeric substrates according to the present invention with a resolution that is less than or equal to that available by ink jet printing techniques (e.g., 567 dots per centimeter (i.e. 1440 dpi)). Electroless plating catalysts and solutions are well known and may be obtained, for example, from Shipley Company (e.g., under the trade designations “CATAPREP” or “CATAPOSIT” (catalysts), “CUPOSIT 385 COPPER MIX” (electroless copper), “RONAMERSE SMT” (electroless nickel immersion gold), “PALLAMERSE SMT” (electroless palladium)).

The present invention will be more fully understood with reference to the following non-limiting examples in which all parts, percentages, ratios, and so forth, are by weight unless otherwise indicated.

### EXAMPLES

Unless otherwise noted, materials used in the examples that follow are readily available from general commercial chemical suppliers, such as, for example, Aldrich Chemical Co. (Milwaukee, Wis.). The following abbreviations are used throughout the examples that follow:

“FEP” refers to a film (51 micrometers thickness) of a copolymer of tetrafluorethylene and hexafluoropropylene, 85/15 by weight having the trade designation “FEP X6307”, obtained from Dyneon, LLC;

“KHN” refers to a film (12 micrometers film thickness) of polyimide having the trade designation “KAPTON HN”, obtained from E.I. du Pont de Nemours and Company;

“PET” refers to a film (61 micrometers thickness) of polyethylene terephthalate having the trade designation “MYLAR TYPE A”, obtained from DuPont Teijin Films U.S. Limited Partnership (Wilmington, Del.).

“BYN” refers to an acid modified ethylene-vinyl acetate copolymer having the trade designation “BYNEL 3101”, commercially available from E.I. du Pont de Nemours and Company. In the examples that follow, pellets of “BYNEL 3101” were pressed to form films having a thickness of from 1.3 to 1.8 millimeters.

General Procedure A for Modifying a Polymer Film

In each of the following examples, the photoreactive material was printed onto a polymer film using a Xaar XJ128-200 piezo ink jet print head (obtained from Xaar PLC). The print head was mounted in fixed position, while the substrate was mounted on an x-y translatable stage. The photoreactive material was printed at a resolution of 317×295 dots per inch (125×116 dots per cm). The solution was printed onto the polymer film in a test pattern consisting of lines, dots, and solid fill squares (2.54 cm×2.54 cm) and circles as shown in FIG. 2.

The printed films were passed through a UV-processor (obtained under the trade designation “FUSION UV PROCESSOR” from Fusion UV Systems) equipped with a single H-type bulb operated at 100 percent power. Each sample was passed five times through the UV-processor at a speed of 40 feet per minute (12 m/min). Afterwards, each polymer film was washed with distilled water and methanol, and then thoroughly dried.

Contact Angle Measurement

Advancing contact angles were measured using deionized water and an apparatus obtained under the trade designation “VCA 2500XE VIDEO CONTACT ANGLE MEASURING SYSTEM” from AST Products (Billerica, Mass.).

### Example 1

A photoreactive material was prepared by mixing 10 grams N,N-dimethylaniline and 90 grams methanol. The photoreactive material was printed onto FEP film and exposed to actinic radiation according to General Procedure A for Modifying a Polymer Film. The advancing contact angle in the printed regions was 72 degrees, compared to a contact angle of 109 degrees in the unprinted regions. The modified FEP film was flood coated with water. The water preferentially wetted the printed regions.

### Example 2

A photoreactive material was prepared by dissolving 3 grams of Na₂S.9H₂0, 3 grams of Na₂S₂O₃, 3 grams of 3-aminopropyltriethoxysilane, and 3 grams of tetrabutylphosphonium bromide in 48 milliliters of water. The photoreactive material was printed onto KHN film and exposed to actinic radiation according to General Procedure A for Modifying a Polymer Film. The advancing contact angle in the printed regions was 30 degrees, compared to a contact angle of 73 degrees in the unprinted regions.

### Example 3

The photoreactive material of Example 2 was printed onto a PET film and exposed to actinic radiation according to General Procedure A for Modifying a Polymer Film. The advancing contact angle in the printed regions was 55 degrees, compared to a contact angle of 109 degrees in the unprinted regions.

### Example 4

The photoreactive material of Example 2 was printed onto an FEP film and exposed to actinic radiation according to General Procedure A for Modifying a Polymer Film. Following the printing and curing steps, the substrate was activated by immersing it for one minute in a water solution containing 0.1 percent by weight aqueous PdCl₂. The substrate was dried and then immersed for one minute in a 0.1 molar aqueous solution of NaBH₄. Finally, the sample was immersed for 5 minutes into a solution prepared by mixing 7.2 grams of NiCl₂, 6.4 grams of NaH₂PO₂, 77 grams of 50 percent by weight aqueous gluconic acid, 2 grams of sodium hydroxide, 5 milliliters of concentrated ammonium hydroxide, and 300 milliliters of water.

This process resulted in nickel being plated selectively onto the printed areas of the FEP substrate.

### Example 5

The photoreactive material of Example 2 was printed onto FEP film and exposed to actinic radiation according to General Procedure A for Modifying a Polymer Film. The photomodified surface of the FEP film was heat-laminated to a BYN substrate in a heated platen press for 2 minutes at 200° C. and 30 kiloPascals pressure. The laminated sample was quenched to room temperature. When the BYN substrate was peeled from the FEP film, there was good resistance to pull apart in the printed regions and no resistance to pull apart in the unprinted regions.

Various modifications and alterations of this invention will become apparent to those skilled in the art without departing from the scope and spirit of this invention, and it should be understood that this invention is not to be unduly limited to the illustrative embodiments set forth herein.

What is claimed is:

1. A method for modifying a surface of a polymeric substrate comprising:
providing a first polymeric substrate having a first surface;
digitally applying a photoreactive material comprising at least one photochemical electron donor to a first region of the first surface; and
exposing at least a portion of the first region to actinic radiation.

2. The method of claim 1, wherein digitally applying comprises at least one of ink jet printing, valve jet printing, and spray jet printing.

3. The method of claim 1, wherein digitally applying comprises ink jet printing.

4. The method of claim 1, wherein digitally applying comprises piezo ink jet printing.

5. The method of claim 1, wherein the substrate comprises at least one of a fluoropolymer, a polyimide, or a polyester.

6. The method of claim 1, wherein the substrate comprises a fluoropolymer.

7. The method of claim 6, wherein the fluoropolymer comprises a perfluoropolymer.

8. The method of claim 1, wherein the photochemical electron donor comprises at least one organic photochemical electron donor.

9. The method of claim 8, wherein the organic photochemical electron donor comprises at least one of an organic amine, an aromatic phosphine, an aromatic thioether, a thiophenol, a thiolate, or mixtures thereof.

10. The method of claim 1, wherein the photochemical electron donor comprises at least one inorganic photochemical electron donor.

11. The method of claim 10, wherein the inorganic photochemical electron donor comprises at least one of a sulfur-containing salt, a selenium-containing salt, an inorganic nitrogen-containing salt, an iodine containing salt, or a mixture thereof.

12. The method of claim 1, wherein the photochemical electron donor comprises at least one inorganic photochemical electron donor and at least one organic photochemical electron donor.

13. The method of claim 10, wherein the photoreactive material further comprises a cationic assistant.

14. The method of claim 1, wherein the photoreactive material further comprises a sensitizer.

15. The method of claim 1, wherein the viscosity of the photoreactive material is less than about 30 mPa·s.

16. The method of claim 1, wherein the actinic radiation comprises ultraviolet radiation.

17. The method of claim 1, wherein the actinic radiation has at least one wavelength in a range of from about 240 nm to about 290 nm.

18. The method of claim 1, further comprising rinsing the first substrate after exposing at least a portion of the first region to actinic radiation.

19. The method of claim 1, further comprising electrolessly metallizing at least a portion of the first region of the first substrate.

20. The method of claim 1, further comprising:
applying a secondary substrate to the first surface of the first substrate after the first region has been exposed to actinic radiation; and
adhering the exposed first region to the first substrate.

21. The method of claim 20, wherein adhering comprises at least one of heating or applying pressure.

22. The method of claim 21, wherein the secondary substrate comprises a polymer.

23. The method of claim 1, further comprising applying a fluid to the first surface of the first substrate after the first region has been exposed to actinic radiation.

24. The method of claim 23, wherein the fluid comprises a polymeric binder.

25. The method of claim 23, wherein the fluid comprises a protein.

26. The method of claim 23, wherein the fluid comprises at least one of flakes, particles, microspheres, retroreflective beads, or fibers.

27. The method of claim 23, wherein applying comprises at least one of spraying, roll coating, or dip coating.

28. An article made by the method of claim 1.

29. An article made by the method of claim 20.

30. An article made by the method of claim 23.
